(19) United States
(12) Patent Application Publication
(10) Pub. No.: US 2003/0146316 A1
(43) Pub. Date: Aug. 7, 2003

(54) Comminution machine or crusher

(76) Inventor: Robert Anthony Crabbe, Oxon (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/296,579

(22) PCT Filed: Mar. 19, 2002
(86) PCT No.: PCT/GB02/01279

(30) Foreign Application Priority Data
Mar. 22, 2001 (GB) 0107142.2

(51) Int. Cl. B02C 1/10

(52) U.S. Cl. 241/101.73

(57) ABSTRACT

A comminution machine is provided for comminuting crushable materials such as rock, masonry and reinforced concrete, or shreddable materials such as motor vehicle tires. The machine comprises a hopper having an open top (11) tapering to a narrower discharge opening (12). The hopper has a curved anvil wall (6) and a curved and reciprocally pivotable crushing jaw (7). Movement of the crushing jaw (7) is controlled by a two-way hydraulic ram (9). The shape of the crushing jaw (7) is generally that of a spiral away from its pivotal axis in a direction from the bottom to the top of the hopper, with the result that reciprocation of the crushing jaw (7) imparts a mixture of compressive and shear forces on comminutable material in the hopper, the sheer forces increasing in proportion nearer to the discharge opening of the hopper.

### TECHNICAL FIELD

The invention relates to machines for comminuting large and bulky materials such as stone, concrete, reinforced concrete, motor car engines and other cast alloy structures, lorry tyres and motor car tyres. The concrete and stone is reduced in the machine to rubble that can be useful in a variety of engineering projects for example as hardcore. Cast alloy structures can be broken up for recycling. Vehicle tyres can be reduced to smaller fragments for burying on a landfill site, or can be comminuted right down to small pieces or strips which can be put to a variety of uses as reclaimed rubber.

### BACKGROUND ART

A number of different classes of machines have been proposed for commuting stone, concrete and demolished masonry. The largest of these known machines, which is known generically as a jaw crusher, is a large and heavy static machine which has a pair of flat jaws arranged in a V-shape to define a crusher hopper. One jaw is fixed, and the other is pivoted at a bottom corner, and in use is vibrated by a heavy flywheel which bears eccentrically on a rear face of the movable jaw. The mass of the flywheel is typically up to 5 tonnes. Material, such as concrete or quarry stone, is fed into the hopper where it is rapidly comminuted by the homer action of the vibrating wall. The comminuted fragments fall as aggregate through a discharge orifice at the bottom of the hopper. Jaw crushers are used primarily in quarries, when up to 1000 tonnes of stone can be comminuted in an hour, the actual throughput depending on the size of the flywheel, the size of the hopper and the softness of the stone. Such known jaw crushers are not however suitable for the comminution of reinforced concrete, as the steel reinforcing bars or mesh of the concrete products being comminuted are discharged vertically downwards through the hopper together with the aggregate. This creates a possibility of material jamming in the discharge orifice. With or without such jamming, subsequent separation of the steel reinforcement and the aggregate can be difficult.

Another known comminution machine which works on a flywheel principle is the so-called pestle and mortar machine. An eccentrically mounted spinning pestle is driven cyclically in a mortar so as repeatedly to impart compression and shear forces on comminutable material in the mortar. The spinning pestle itself may have sufficient mass to act as a flywheel, or it may be attached to a flywheel of substantial mass. Pestle and mortar comminution machines are useful in quarries, but not for the comminution of reinforced concrete because the steel reinforcement bars or mesh do not pass readily through the mortar.

Another comminution machine which has been proposed and which does have the advantage of being able to handle reinforced concrete is a so-called muncher which has two toothed jaws, one or both of which may be hydraulically activated. The muncher imparts purely compressive forces on material between the jaws which are moved reciprocally by a hydraulic ram. The muncher can comminute reinforced concrete by repeatedly compressing the concrete between the jaws, and then releasing it, until the concrete crumbles. As it crumbles, the concrete separates as aggregate from the reinforcing rods, and if necessary the same jaws can be used to pick up the steel reinforcement from the pile of comminuted aggregate. The machine can handle up to about 9 tonnes per hour of quarry stone, and can be mounted on a hydraulic arm of a digger/excavator.

It is an object of the invention to provide a comminution machine of a general type that can accept a wide range of comminutable materials, including quarry stone, cast metal structures, reinforced concrete and automobile tyres. A secondary objective is to create a comminution machine that is robust, reliable and sufficiently compact to permit it to be mounted in or as the front bucket of an excavator.

### DISCLOSURE OF INVENTION

According to a first aspect of the present invention there is provided a comminution machine comprising a hopper for receiving comminutable material, having an open top tapering to a narrower discharge opening at the bottom, the hopper having a curved anvil wall facing a working face of a curved crushing jaw which is reciprocally movable about a pivotal axis that is near to the bottom of the hopper and is displaced rearwardly from the working face of the crushing jaw, wherein the crushing jaw curves generally in a spiral away from its pivotal axis in a direction from the bottom to the top of the hopper and a two-way hydraulic ram acts on the crushing jaw for imparting reciprocal pivotal movement thereto so as to impose a mixture of compressive and shear forces on comminutable material in the hopper, the shear forces increasing in proportion nearer to the discharge opening of the hopper.

According to a first preferred version of the first aspect of the present invention the curved crushing jaw is reciprocally movable by the hydraulic ram through an arc of from 20° to 60° relative to the anvil wall.

According to a second preferred version of the first aspect of the present invention or of the first preferred version thereof the spiral form of the crushing jaw approaches a tangent to a radius centred on the pivotal axis at the discharge opening of the hopper.

According to a third preferred version of the first aspect of the present invention or any preceding preferred version thereof the anvil wall is formed from a number of plates in stepped formation, over which the comminutable material must pass in its passage from the open top of the hopper to the discharge opening.

According to a fourth preferred version of the first aspect of the present invention or any preceding preferred version thereof the distance between the pivotal axis of the curved crushing jaw and the anvil wall can be varied so as to vary the width of the discharge opening and thereby vary the average size of the fragments of comminuted material passing through the discharge opening.

According to a fifth preferred version of the first aspect of the present invention a comminution machine according to the third or fourth preferred versions thereof the crushing jaw is toothed for gripping the commutable material to enhance the shear forces imparted thereto. Typically such a comminution machine is adapted for crushing reinforced concrete and separating the steel reinforcing rods from the crushed concrete, wherein the curved anvil wall is shaped and angled so as to deflect the steel reinforcing rods passing through the discharge opening from the path of the crushed concrete which falls under gravity from the discharge opening.

According to a sixth preferred version of the first aspect of the present invention or of the first or second preferred versions thereof is adapted for the comminution of motor tyres, wherein the anvil wall includes a first set of vertical blades facing the crushing jaw, and the crushing jaw includes a second set of vertical lades facing the anvil wall, the blades of the two sets being sized, shaped and positioned to come into face-to-ace contact in use to impart a scissoring effect which cuts any motor tyres placed between the crushing and anvil walls of the hopper. Typically the blades of each set are mutually spaced apart by a distance of from 50 to 200 cm, so that a motor tyre passing tough the hopper is cut into at least eight pieces. The blades of each set can be mutually spaced apart by a distance of about 2 to 4 cm, so that a motor tyre passing through the hopper is cut into small strips or fragments of width no m re than the said 2 to 4 cm.

According to a second aspect of the present invention there is provided bucket for an excavator equipped with a comminution machine according to the first aspect of the present invention or any preceding preferred version thereof wherein the hopper is mounted in the bucket so that comminutable material can be scooped into the open top of the hopper by the excavator bucket action, and delivered from the discharge opening as comminuted fragments delivered to a discharge location.

A comminution machine according to the first aspect of the present invention or any preceding preferred version thereof wherein the hopper is freestanding. Typically the two-way ram is supplied with hydraulic fluid under pressure from a pressure source powered by an internal combustion engine or an electric motor.

In a practical embodiment the hopper tapers from its open top to its narrower discharge opening at the bottom. That should be a continuous and preferably uniform taper, with the width of the discharge opening determining the particle size of the comminuted material and the maximum throughput of the machine.

A comminution machine according to the invention may be used for the comminution of rock in a quarry; for the comminution of demolished masonry and concrete, including reinforced concrete; for the breaking up of motor car engines and other cast alloy structures; or for the comminution of motor vehicle tyres.

The most important use of the comminution machine according to the invention is likely to be the comminution of reinforced concrete or of masonry including reinforced concrete. The increasing shear forces on the reinforced concrete as it progresses down the hopper towards the discharge opening is effective to strip the concrete away from its reinforcement, and the curved crushing jaw and anvil wall are preferably shaped and oriented to discharge the reinforcing rods, bars or mesh with a lateral component of movement to the side of the crushed aggregate which falls vertically from the hopper.

The comminution machine may be sufficiently compact to be mounted in or as the front bucket of an excavator. Alternatively it may be freestanding as a static machine which may be incorporated into a production lie being fed and discharged by conveyors. If designed as a static machine, the source of hydraulic fluid under pressure for the two-way ram may be powered by an internal combustion engine or by an electric motor.

If the comminution machine is designed to cut up motor vehicle tyres, the tyres may be cut into pieces, as few as eight pieces per tyre, for disposal in a landfill site; or into small strips as narrow as 2 cm to 4 cm in width, or fragments of average size no more than 2 cm to 4 cm. The machine is particularly well suited to cutting tyres into strips about 2 cm to 4 cm in width and up to 30 cm in length, and such strips have many useful commercial applications such as a free-draining surface covering for equestrian use.

To cut a motor tyre, the anvil wall preferably includes a first set of vertical blades facing the crushing jaw, and the crushing jaw includes a second set of vertical blades facing the anvil wall, the blades of the two sets being sized, shaped and positioned to lap over one another in face-to-face contact, in order to impart a scissoring effect on any material placed between the walls. Thus any motor tyres placed between the anvil wall and the crushing jaw will be cut initially into strips and then commuted further if its exit from the discharge opening of the hopper is restricted.

### BRIEF DESCRIPTION OF DRAWINGS

FIG. 1 illustrates schematically a hydraulic arm digger carrying, in place of a conventional bucket, a comminution machine according to the invention;

FIG. 2 is a vertical schematic section through the comminution machine of FIG. 1;

FIGS. 3a and 3b are vertical sections corresponding to that of FIG. 2, but with the anvil wall in two alternative positions corresponding to different width discharge openings; and

FIG. 4 is a perspective view from above and one side of a modification of the comminution machine of FIG. 2, modified to cut vehicle tyres into at least eight pieces,

### MODE FOR CARRYING OUT THE INVENTION

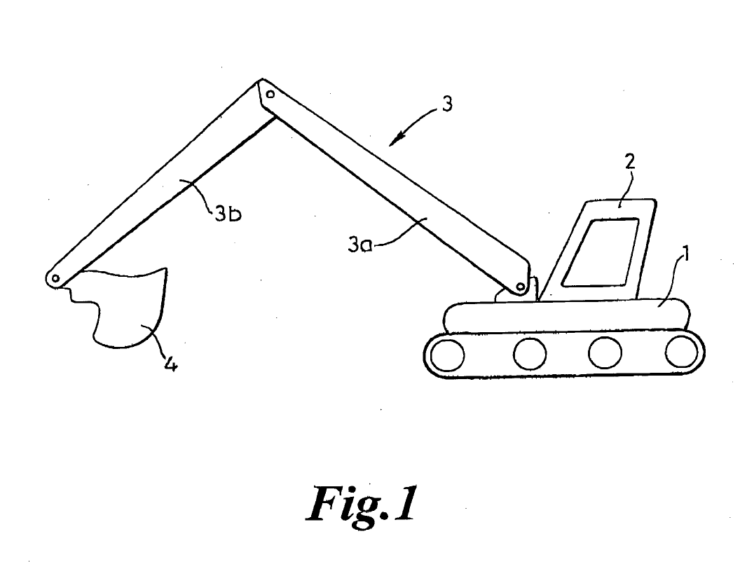

Referring first to FIG. 1, there is shown schematically a digger of the kind conventionally used on building sites or in quarries, comprising a caterpillar tracked body Ion which is mounted a cab 2 and a hydraulic arm assembly 3. The hydraulic arm assembly 3 is a double link arm of which one of the two links 3a and 3b may be telescopically extensible. At the distal end of the link 3b is mounted a comminution machine 4 according to this invention, which also acts as a bucket of the digger. The pivotal mountings of the first link 3a to the digger body 1, of the second link 3b to the first link 3a, and of the comminution “machine 4 to the second link 3b are hydraulically controlled from the cab 2. A, further hydraulic control actuates the crushing and comminution action of the machine 4, as will be described below.

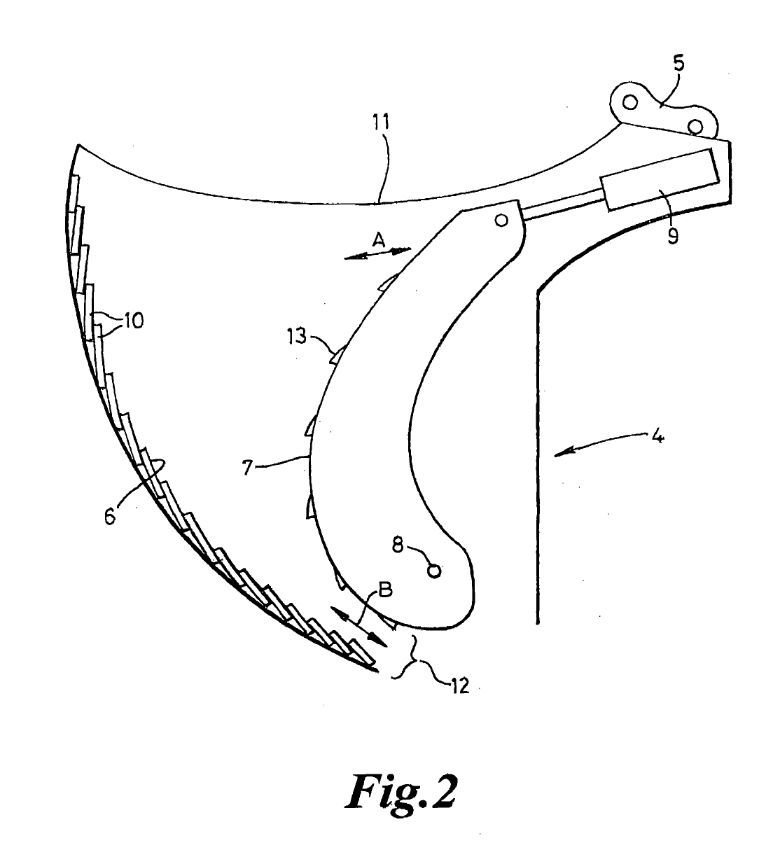

FIG. 2 is a schematic section through the bucket which incorporates the comminution machine 4. A linkage shown generally as 5 permits the bucket 4 to be mounted on the hydraulic arm 3b and rotated hydraulically. Inside the bucket is a hopper formed by a cured anvil wail 6 and a curved crushing jaw 7. Tie anvil wail 6 is fixed, but the crushing jaw 7 is pivotally mounted at 8 relative to the anvil wall, and is capable of two-way pivotal movement around the pivot pin 8 under the influence of a two-way hydraulic ram 9. The total angular extent of pivotal movement can be anything from about 200 to 60° relative to the fixed anvil wall. The anvil wall 6 is made up of a series of plates 10 in cascading stepped formation, over which comminutable material in the hopper must pass in its progress from an open top 11 of the hopper to a discharge opening 12,

The shape of the curved crushing jaw 7 is that of a spiral outwardly and away from the pivotal axis 8 in the direction from the bottom to the top of the hopper. The crushing face of the wall 7 is shown as incorporating teeth 13 which are downwardly inclined so as positively to grip the lumps of comminutable material as it passes into and down the hopper. In use, the comminution surface 7 imparts a substantially linear crushing stress on the comminutable material near the open top 11 of the hopper, but further down and nearer the discharge opening at the bottom, the slopes of both the anvil wall 6 and the comminution wall 7 are closer to becoming tangents to a circle centred on the pivot pin 8, so that a very substantial part of the total forces imposed on the comminutable material are shear forces. The transition from largely compressive to largely shear forces is progressive,” so that as the commuting wall 7, is moved reciprocally under the action of the double acting ram 9, the two-way movement in the direction of the double headed arrow A near the mouth 11 of the bucket 4 imposes substantially wholly compressive forces on the comminutable material in the bucket, whereas the movement in the direction of the double headed arrow B near the discharge orifice imparts substantially wholly shear forces. Moreover those shear forces have the effect of physically advancing the comminutable material down the hopper towards the discharge opening 12, by virtue of the shape of the teeth 13. The comminutable material is broken up by this action, and falls as small pieces of crushed aggregate from the discharge opening 12.

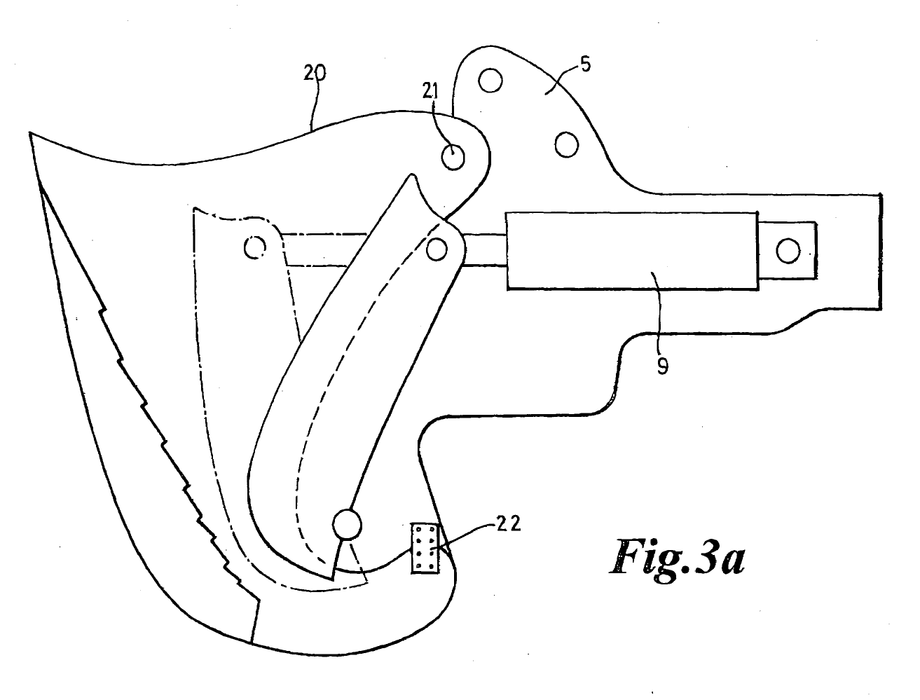

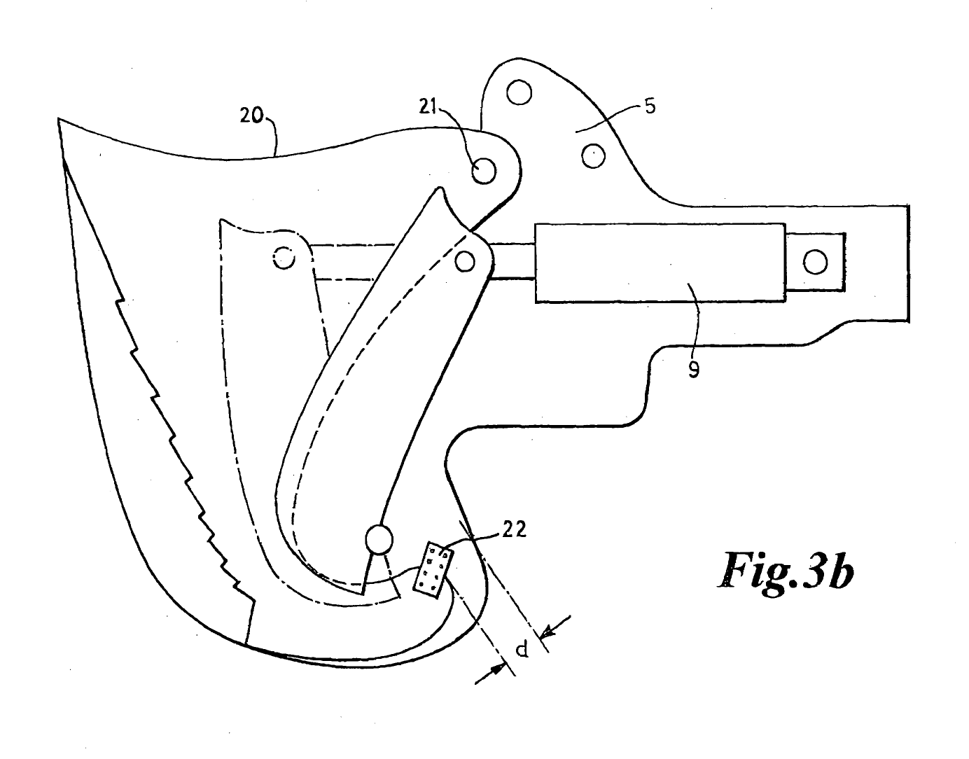

All of the components are made from materials that are strong enough, or reinforced to be strong enough, to avoid buckling in use. The throat width of the discharge opening is variable as is illustrated in FIGS. 3a and 3b. Side walls 20 of the hopper are pivotally supported near the linkage S by pivot pins 21, and are secured against pivotal movement at the bottom by bolted plates 22. By moving X bolted plates 22 (for example from the position of FIG. 3a to that of FIG. 3b) the throat width can be enlarged by a distance “d” Intermediate throat widths can also be defined. The bolts securing the plates 22 are shear bolts, so that they will shear before the other components of the bucket are damaged in the case that the reciprocal movement of the comminuting face 7 is jammed or otherwise blocked.

The main bearing for the curved crushing jaw 7, for journalling the jaw for pivotal movement about the axis 8, is designed to allow the jaw to be removed quickly and easily for maintenance purposes, and also permits the jaw to be exchanged for another jaw having a different profile for counting different materials. The fixing point for the hydraulic ram 9 also benefits from a quick release pin and shackle coupling.

The stroke of the ram 9 is preferably adjustable between preset limits from a control panel while the machine is in use, to allow a wide range of differently sized feedstock to be loaded into the machine with no little or loss of efficiency. The control panel also allows the machine operator to exert a fine control over the size of the material being discharged.

### INDUSTRIAL APPLICABILITY

Materials that can be commuted by the apparatus of FIGS. 1 and 2 include quarried stone, building demolition materials such as broken masonry and concrete, and metal castings such as motor car engines. If the comminutable material is reinforced concrete, then the shape of the bucket aids the separation of the reinforcing bars from the crushed aggregate, because the discharge opening at the bottom of the hopper is inclined at a very significant angle to the vertical, so that the reinforcing rods are discharged with a significant lateral component of movement whereas the crushed aggregate falls vertically down through the discharge opening.

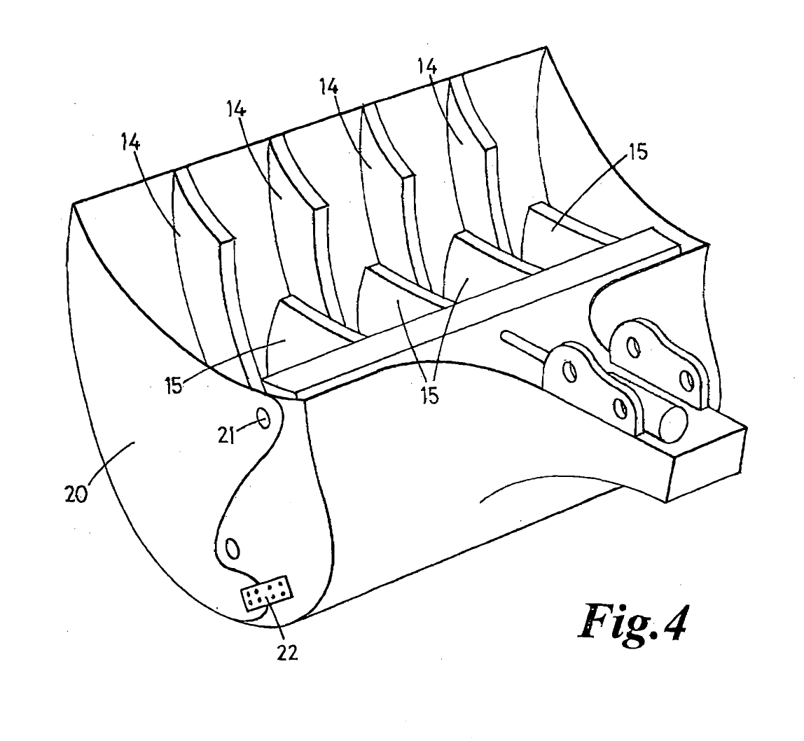

FIG. 4 shows a modification to the shape of the curved walls 6 and 7 to enable the machine to cut motor vehicle tyres into at least eight pieces before burying them on a landfill site. A row of vertically aligned blades 14 extend from the anvil wall 6 inwardly into the hopper towards the comminuting wall 7, and a corresponding array of co-operating blades 15 extend from the comminuting wall 7 to lie closely alongside the blades 14 in face-to-face contact, so that the two sets of blades have a scissors action one against the other. When motor vehicle tyres are scooped up by the bucket, actuation of the double-acting ram 9 causes the tyres to be sliced vertically by the two sets of blades, while the shear action near the discharge opening of the bucket draws the cut tyre fragments out through the discharge opening.

The blades 14 and 15 of each set are mutually spaced apart, by a distance of from 50 to 200 cm, which is sufficient to ensure that a motor tyre passing through the hopper is cut into at least 8 pieces. By increasing the number of blades 14 and 15, the tyre can be cut into progressively smaller pieces. The size of the discharge opening 12 determines the number of repeated jaw movements required to comminute each tyre, so that the final comminuted product can be anything from strips of rubber, preferably about 2 cmn wide, to chopped fragments of rubber having a width and length of approximately 2 cm. Both of these products are suitable for the creation of a cushioned surface such as an equestrian riding surface.

1. A comminution machine comprising a hopper for receiving comminutable material, having an open top tapering to narrower discharge opening at the bottom, the hopper having a curved anvil wall facing a working face of a curved crushing jaw which is reciprocally movable about a pivotal axis that is near to the bottom of the hopper a d displaced rearwardly from the working face of the crushing jaw, wherein the crushing jaw curves generally in a spiral away from its pivotal axis in a direction from the bottom to the top of the hopper, and a two-way hydraulic ram acts on the crushing jaw for imparting reciprocal pivotal movement thereto so as to impose a mixture of compressive and shear forces on comminutable material in the hopper, the shear forces increasing in proportion nearer to the discharge opening of the hopper

2. A comminution machine according to claim 1 wherein the curved crushing jaw is reciprocally movable by the hydraulic ram through an arc of from 20° to 60° relative to the anvil wall.

3. A comminution machine according to either preceding claim, wherein the spiral form of the crushing jaw approaches a tangent to a radius centred on the pivotal axis at the discharge opening of the hopper.

4. A comminution machine according to any preceding claim, where the anvil wall is formed front a number of plates in stepped formation, over which the comminutable material must pass in its passage from the open top of the hopper to the discharge opt.

5. A comminution machine according to any preceding claim, where the distance between the pivotal axis of the curved crushing law and the anvil wall can be varied so as to vary the width of the discharge opening and thereby vary the average size of the fragments of comminuted material passing through the discharge opening.

6. A comminution machine according to claim 4 or claim 5, wherein t e crushing jaw is toothed for gripping the comminutable material to enhance the shear forces imparted thereto.

7. A comminution machine according to claim 6, for crushing reinforced concrete and separating the steel reinforcing rods from the crushed concrete, wherein the curved anvil wall is shaped and angled so as to deflect the steel reinforcing rods passing through the discharge opening from the path of the crushed concrete which falls under gravity from the discharge opening.

8. A comminution machine according to any of claims 1 to 3 for the comminution of motor tyres, wherein the anvil wall includes a first set of vertical blades facing the crushing jaw, and the crushing jaw includes a second set of vertical lades facing the anvil wall, the blades of the two sets being sized, shaped and positioned to come into face-to-ace contact in use to impart a scissoring effect which cuts any motor tyres placed between the crushing and anvil walls of the hopper.

9. A comminution machine according to claim 8, wherein the blades a each set are mutually spaced apart by a distance of from 50 to 200 cm, so that a motor tyre passing through the hopper is cut into at least eight pieces.

10. A comminution machine according to claim 8, wherein the blades a each set are mutually spaced apart by a distance of about 2 to 4 cm, so that a motor tyre passing through the hopper is cut into small strips or fragments of width no m re than the said 2 to 4 cm.

11. A comminution machine according to any preceding claim, wherein the hopper is mounted as a front bucket of an excavator, so that comminutable material can be scooped into the open top of the hopper by the excavator bucket action, and delivered from the discharge opening as comminuted fragments delivered to a discharge location.

12. A comminution machine according to any of claims 1 to 10, wherein the hopper is free-standing.

13. A comminution machine according to claim 12, wherein the two-way ram is supplied with hydraulic fluid under pressure from a pressure source powered by an internal combustion engine or an electric motor.
